(19) United States
(12) Patent Application Publication
(10) Pub. No.: US 2007/0122034 A1
(43) Pub. Date: May 31, 2007

(54) Face detection in digital images

(75) Inventor: Ron Maor, London (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: PIXOLOGY SOFTWARE LIMITED

(21) Appl. No.: 11/361,354

(22) Filed: Feb. 24, 2006

(30) Foreign Application Priority Data
Nov. 28, 2005 (GB) 0524137.7

(51) Int. Cl. G06K 9/00

(52) U.S. Cl. 382/181

(57) ABSTRACT

A method of detecting a face in a digital image comprises generating a map from the image, the map having a plurality of elements each corresponding to a pixel of the image, and searching the map for regions of elements corresponding to regions of pixels in the image exhibiting characteristics of a face. The map may have elements corresponding only to a small proportion of the pixels in the original image. Validation of regions exhibiting the characteristics of a face may include matching against templates. Once the location and size of a face has been identified it may be passed to the control system of a camera to enable the camera to focus on that face and/or select a suitable photograph exposure to optimise the exposure of that face.

### FIELD OF THE INVENTION

The present invention relates to face detection in digital images. In particular, although not exclusively, the invention relates to a system for identifying a face to enable a camera to focus on that face and/or control the exposure of a photograph to optimise the exposure of the face.

### BACKGROUND TO THE INVENTION

A large proportion of photographs, especially those taken by recreational photographers, include people. In such situations, it is important that the camera focuses on the faces in the composition rather than on anywhere else in the picture. For some portrait photography a wide aperture is deliberately used to ensure that the face is in focus but all the surroundings are blurred.

Ensuring that the face is in focus can be problematic, especially in cases where the face is not in the centre of the picture. Many cameras automatically focus on a point in the centre of the field of view. If this point is located at a different distance from the camera than the face, then the face may end up out of focus. Some cameras overcome this problem by enabling the user to select a point of the composition as a focus point. The user starts by lining up his chosen focus point in the centre of the field of view. He then half depresses the camera shutter release button to ensure that the camera focuses at that distance. The camera can then be moved laterally if it is desired that the focus point is off-centre. However, this makes the process of preparing to take a picture slow and unwieldy. In many cases the user would prefer to be able simply to point the camera and take the picture, without having to worry about selecting the point of focus.

Other cameras select one point from a plurality of points on which to focus. This will work in some situations, but the user has very little control over which point is selected by the camera, and in some situations the wrong point is selected, resulting in the face being out of focus in the final image.

It would therefore be desirable to provide a system by which a camera can identify that a face is present, and focus automatically on the part of the field of view containing that face.

A further problem often encountered during portrait photography involves the exposure of the face. Modem cameras detect how much light enters the lens and adjust the aperture and shutter speed to optimise the exposure. However, the light of the entire field of view may not be appropriate for selecting the exposure when it is the face itself which is the subject. For example, if a photograph is taken outdoors, with a large expanse of bright blue sky in the background, a typical camera will recognise that the ambient light is very bright, and ensure that the light entering the lens is reduced. This may result in the face being under-exposed, especially if the face is shaded. Conversely, if the background is generally dark, the camera will increase the amount of light entering the lens, and the face may be over-exposed.

It would thus be desirable to enable the camera to control the exposure of the photograph on the basis of the part of the field of view containing a face only. The exposure of the whole image can then be selected to optimise the exposure of the face itself.

Most modem digital cameras are provided with an array of photodetectors behind the lens which receive light even when a picture is not actually being taken. The array of photodetectors records a series of images, which are transferred to a buffer memory and displayed successively on a liquid crystal display (LCD), normally located on the back of the camera. When the user wishes to “take a picture”—i.e. record the image currently visible on the LCD—he presses an actuating button which causes the camera to focus, the aperture to reduce, and the operating system to record the output from the array of photodetectors onto a memory device such as a memory card.

Since an image of the field of view is constantly determined by the camera for transferral to the LCD, even when this image is not being recorded, it can still be used to provide information to the control system of the camera. If the presence of a face in this image can be detected, the location and size of the face can be passed to the control system so that the camera can focus on the part of the field of view containing the face and/or control the exposure of the picture on the basis of the brightness of the face. It will be appreciated that such face detection must operate extremely rapidly so that the camera can begin focussing and/or selecting the correct exposure as soon as the decision to take a picture has been made.

It is therefore an object of the present invention to provide a system for detecting faces in a digital image. It is a further object to provide a system capable of detecting a face sufficiently rapidly to be usable by the control system of a camera to focus on and/or select exposure on the basis of the brightness of that face.

### STATEMENT OF THE INVENTION

In accordance with one aspect of the present invention there is provided a method of detecting a face in a digital image, the method comprising:
forming a sampled image from a plurality of pixels selected from the digital image; and
searching the sampled image for regions of pixels exhibiting characteristics of a face.

A considerable time saving can be obtained by reducing the number of pixels which need to be searched. The image size is reduced by ignoring most of the pixels in the image, and performing all subsequent operations on just a selection of these pixels. This is distinct from the process of compressing an image to reduce its size, which is a much more time consuming operation. Since a face will always occupy a significant number of pixels, sufficient information is contained in just a small selection of these pixels.

A suitable method for forming a sampled image includes selecting pixels from one out of every m rows and one out of every n columns of the digital image, where m and n are integers greater than one. m and n may be the same. For example, an image having 1000 rows and 1200 columns may be reduced in size by selecting one pixel out of five in each direction to form a sampled image having 200 rows and 240 columns.

Pixels in a digital image are usually described in terms of data in a colour space. Typical systems describe pixels in terms of the levels of red, blue and green of each pixel (typically known as RGB), or hue, luminance and saturation (HLS), although other systems are also known. A common system used in digital cameras is known as YCC. Most systems provide for 256 possibilities for each attribute (e.g. R, G or B), so an individual pixel can have up to 16.7 million (256×256×256) different RGB values.

In accordance with another aspect of the invention there is provided a method of detecting a face in a digital image, comprising generating a map from the image, the map having a plurality of elements each corresponding to a pixel of the image, and searching the map for regions of elements corresponding to regions of pixels in the image exhibiting characteristics of a face.

The use of a map enables the colour space data of pixels in the image to be replaced by map elements containing more focussed information, speeding up subsequent operations in detecting regions corresponding to a face. In preferred embodiments the map is produced from the sampled image described above. In order to keep the total data held by the map as small as possible, the map preferably contains 256×256 elements or fewer, each element being represented by one byte of information (i.e. a value between 0 and 255).

The map is preferably populated from a look-up table. This enables the value of each map element to be determined quickly. As an example, the look-up table may be a matrix of 64×64×64 bytes, with the inputs being the R, G and B values of each pixel scaled down by a factor of 4.

The map element values are preferably subdivided into categories, at least one of the categories corresponding to pixels exhibiting skin tone, so that map elements in the category or categories corresponding to skin tone pixels may be classed as “skin tone elements”. More than one skin tone category may be used, to cover a range of values, both dark and light, to account for factors such as skin colouration and lighting conditions. Further categories may be provided for pixels corresponding to eyes, lips, hair etc.

Preferably, if the number of skin tone elements in the map is smaller than a predetermined value, it is determined that no face is present in the digital image.

In a preferred embodiment, the step of searching for regions of elements which could correspond to a face begins by searching for “skin tone regions” of skin tone elements. These are generally contiguous regions of skin tone elements, although it will be appreciated that such regions need not necessarily contain only skin tone elements. For example, the elements corresponding to the pixels representing the eyes and mouth, and in some cases the nose, will usually not be skin tone elements, but will still fall within the overall skin tone region.

Preferably, if a skin tone region is below a predetermined size (e.g. one or two elements), it is determined that this region does not correspond to a face in the digital image. Especially in the case of portrait photography, faces will occupy a significant proportion of the image, and will therefore always be above a certain minimum size. This step enables artefacts which happen to have skin tones to be ignored.

Preferably the categories of some or all of the elements in a skin tone region are merged on the basis of the categories of all the elements in that skin tone region. This step reduces the number of different categories of elements, decreasing complexity in subsequent steps.

Preferably, if the shape of a skin tone region is far from elliptical (e.g. the region is generally linear), it is determined that this region does not correspond to a face in the digital image. Thus regions whose shape is unreasonable for the purposes of face detection can be rejected early in the procedure.

A validation may now be performed on each skin tone region to determine whether or not it corresponds to a face in the digital image. The same validation may be repeated up to four times, following rotation of the map each time, to account for different orientations of faces (i.e. extending vertically or horizontally) in the image.

The validation preferably includes identifying the height: width ratio of each skin tone region and determining that a skin tone region whose height: width ratio falls outside predetermined parameters does not correspond to a face in the image.

The validation preferably includes determining a bounding box for a skin tone region by identifying the smallest rectangular shape encompassing the skin tone region, calculating what proportion of elements within the bounding box are skin tone elements and, if the proportion falls outside predetermined parameters, determining that the skin tone region does not correspond to a face in the image. A “face” shape will typically occupy approximately 60-80% of its bounding box.

It will be appreciated that a skin tone region may be larger than the face of a subject. For example, the subject may be wearing a “V” neck which leaves the neck exposed, or even have one or both shoulders exposed. It is useful to be able to identify that faces are present in such situations, even though the skin tone region will not initially appear to be “face”-shaped. It is also useful to be able to determine the location and size of the face itself within the skin tone region.

The validation step preferably includes dividing the bounding box vertically into a plurality of segments (e.g. three segments) extending across the width of the box; calculating, for each segment, a weighted horizontal centre of the skin tone elements contained in that segment; calculating, for each segment, a maximum width of the portion of the skin tone region contained in that segment; and using predetermined rules to examine properties of the segments relative to each other and/or the bounding box. Suitable rules include testing for one or more of the relative horizontal position of the weighted horizontal centres, the relative size of the maximum widths, and the height of the bounding box, although it will be appreciated that other factors may also be considered. This enables the detection of faces present by themselves, or faces present when the subject's neck is exposed, or the neck and one shoulder, or other possibilities that will be apparent.

If the skin tone region satisfies none of the predetermined rules, it is preferably determined that the associated skin tone region does not correspond to a face in the image. If the skin tone region does satisfy one of the predetermined rules, that rule may be used to determine the location and size of a “face region” within the associated skin tone region which could correspond to a face in the image. If only the face itself is uncovered, the face region and skin tone region will be substantially the same. If the neck or shoulder(s) are exposed, the face region may well be considerably smaller than the skin tone region.

Once the face region has been identified, it is preferably matched against a plurality of face-shaped templates to determine if it does correspond to a face in the image. Each template may be divided into regions within the bounding box where a high proportion of skin tone elements is expected (i.e. corresponding to skin regions of the face), and other regions where a low proportion of skin tone elements is expected, for example corresponding to eyes, lips, hair etc. Further regions may have a “neutral” expectation of skin tone elements: for example, ears may be visible or may be covered by hair. In the region of the nose, it would be expected that some elements are skin tone elements but the majority are not, because the nose often appears a different colour due to its angle.

Some regions of each template (e.g. eyes, lips, hair) corresponding to a low expectation of skin tone elements may have high expectations of other categories of element.

The step of matching the face region to each template may preferably include applying a score to each element on the basis of how well the category of that element matches the expected category in the region template in which it is located.

Further selection criteria may be applied to each face region to determine whether or not it corresponds to a face in the image. For example, the relative sizes of eye regions and mouth regions within each face region may be compared. The symmetry of the eye regions may be checked.

If a face region meets all of the above criteria, it may be considered to correspond to a face in the original image. The location and size of the face may then be passed to a camera for use in focussing on that face and/or other purposes such as selecting exposure on the basis of the brightness of the face.

The invention thus also provides a camera which is arranged to carry out face detection as described above. There is also provided a method of focussing a camera onto a face, comprising detecting a face using a method as described above, and focussing onto that face. There is also provided a method of selecting the exposure of a photograph, comprising detecting a face using a method as described above, and selecting the photograph exposure to optimise the exposure of that face.

It will be appreciated that the above described steps need not all be used in the detection of a face. Many of the operations may be used independently, although the overall efficiency is increased if all are used. For example, skin tone regions may be detected directly in the original image, or in a sampled image, without the creation of a map, although the use of a map is preferred because it decreases computational complexity. Skin tone regions may be compared to templates whether or not the previous validation steps have taken place first, although template matching will take longer if no previous filtering has been performed. Similarly, validation may be performed without rejecting “abnormal” (e.g. linear) shapes first, but will be less efficient.

Thus according to another aspect of the invention there is provided a method of detecting a face in a digital image, the method comprising:
identifying skin tone regions of pixels in the image having colour space values characteristic of skin colour;
determining a bounding box for a skin tone region by identifying the smallest rectangular shape encompassing the skin tone region;
dividing the bounding box vertically into a plurality of segments extending across the width of the box;
calculating, for each segment, a weighted horizontal centre of the skin tone pixels contained in that segment by calculating the mean of the horizontal co-ordinates of the skin tone pixels in the segment;
calculating, for each segment, a maximum width of the portion of the skin tone region contained in that segment;
using predetermined rules to examine properties of the segments relative to each other and/or the bounding box; and
passing or rejecting each skin tone region as corresponding to a face on the basis of the predetermined rules.

According to a further aspect of the invention there is provided a method of detecting a face in a digital image, the method comprising:
identifying skin tone regions of pixels in the image having colour space values characteristic of skin colour;
comparing each skin tone region with a plurality of face-shaped templates;
passing a skin tone region as corresponding to a face if it matches at least one of the templates.

### BRIEF DESCRIPTION OF THE DRAWINGS

Some preferred embodiments of the invention will now be described by way of example only and with reference to the accompanying drawings, in which:

FIG. 1 is a schematic representation of a digital image containing a face;

FIG. 2 is a schematic representation of a map of the image of FIG. 1;

FIGS. 3A and 3B are schematic representations of two forms of skin tone regions, each including a face;

FIGS. 4A and 4B show the face regions of the skin tone regions of FIGS. 3A and 3B; and

FIG. 5 shows a typical template used in face validation.

### DETAILED DESCRIPTION OF THE PREFERRED EMBODIMENTS

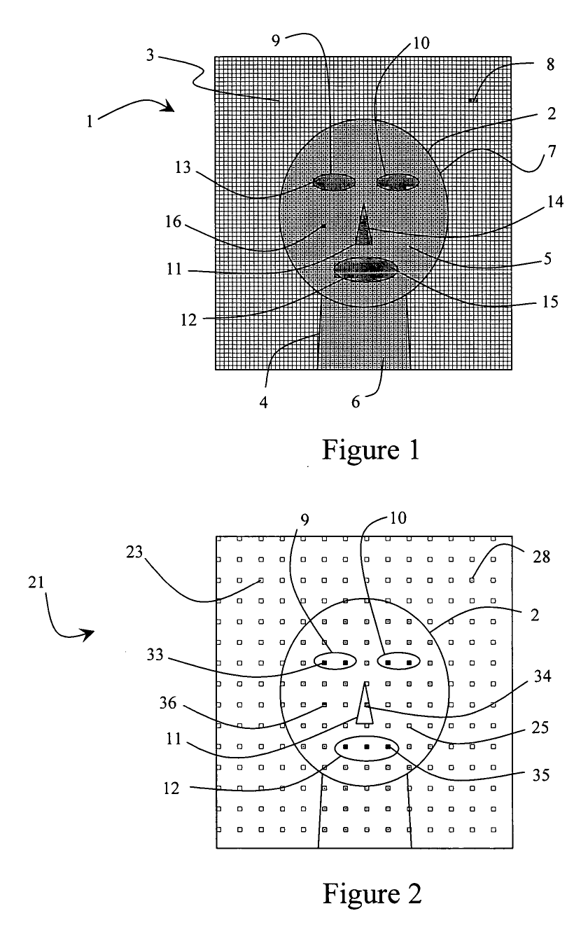

FIG. 1 is a schematic representation of an exemplary digital image 1 of a face 2. The image 1 is formed of 70×75 pixels 3. It will be understood that, in practice, digital images have far more pixels than shown in FIG. 1: typical images range from 160×240 pixels upwards to 12 Megapixels (e.g. 3000×4000 pixels) or even more. However, the principle of the image can be seen from FIG. 1.

As can be seen from FIG. 1, the image includes a face region 2 and neck region 4. The pixels 5, 6 within the face region and neck regions are the colour of human skin, or “skin tone” pixels. The face and neck thus together form a “skin tone region” 7. The range of colours (or RGB values) of skin tone pixels varies from light to dark so as to include different skin types and lighting conditions, but is still small compared to the full colour range possible. Due to the need to cover all (or most) skin types, many non-skin pixels also fall within this range—examples include those found on light wood, light hair, cardboard, and red bricks. The image 1 also contains a small patch 8 of skin tone colour in the background, which could occur, for example, if the background is an off-white wall.

Contained within the skin tone region 7 are also found regions corresponding to the eyes 9,10, nose 11 and mouth 12. The pixels found in such regions will generally not be skin tone pixels: the pixels 13 in the eyes 9, 10 may, for example, be generally blue, the pixels 14 in the nose 11 a colour defined by a shadow caused by light falling on the nose, and the pixels 15 in the mouth 12 red. It will also be noted that, even outside the area of the eyes, nose and mouth, not all pixels in the skin tone region will necessarily be skin tone pixels: pixels 16 with other colours may be caused by a birthmark or other similar mark such as a blemish or a wound on the face, or may be the result of colour distortion caused by the camera and/or lighting conditions.

In order to process the image 1 shown in FIG. 1, a map 21 is populated as shown in FIG. 2. The map 21 comprises 14×15 elements 23, each corresponding to one pixel 3 from FIG. 1. In this example, a map element is generated for every fifth pixel in each direction from the image 1. The map is populated from a look-up table, which translates every pixel value (of the 14×15 pixels selected) to a value that fits in an element 23 of the map 21. This may be achieved by a table of 64×64×64 bytes. The input of the table is the RGB value of a selected pixel scaled down by a factor of 4. The output byte is entered into the corresponding map element 23.

The values entered into the map elements 23 may be seen as providing “categories” of pixels 3. This is a finer distinction than simply “skin tone” or “not skin tone”. The categories distinguish between colours which are skin tone, but too dissimilar to be considered the same skin tone. A suitable number of categories for the different types of skin tone is of the order of 128, providing information about how bright, red, saturated etc. the corresponding pixel 3 is. Thus there may be approximately 128 categories of “skin tone elements”. The remaining categories may be used for elements corresponding to pixels not having skin tone, and some may be used for colours characteristic of eyes, hair, mouth etc.

The 14×15 element map 21 shown in FIG. 2 is intended to be exemplary only, and the final number of pixels in the map has been reduced much further than necessary in order to show the principle of operation. In practice, a typical map will keep the aspect ratio of the original image, and a maximum size such as 256×256 elements may be selected. As an example, for an image of 1000×1200 pixels, every fifth pixel in each direction might be selected, so that the populated map would comprise 200×240 elements. Alternatively, the selection of pixels might be chosen to ensure that the entire map is populated.

It can be seen in even the very sparsely populated exemplary map 21 that there are seventy-one elements within the skin tone region 27. Sixty-one of these elements 25 (“skin tone elements”) correspond to skin tone pixels 5 in the original image 1. There are also two “eye” elements 33 in each eye 9,10, one “nose” element 34 in the nose 11, three “mouth” elements 35 in the mouth 12, and one “blemish” element 36 corresponding to the birthmark 16. Thus, even with the very low number of map elements shown in FIG. 2, it can be seen that there is sufficient information to conduct further tests to see if the collection of skin tone elements 25 forming the skin tone region 2 actually corresponds to a face.

Once the map has been populated, a check is made of the total number of skin tone elements. If too few are present, a report is made that no face is present in the image and the process stops. A typical threshold value for a 200×240 element map is approximately 200 elements.

If there is a significant number of skin tone elements, the detection stage begins. The first stage involves merging the categories of those elements whose categories are similar, according to predefined metrics. For example, two categories that differ only in that one is lighter than the other may be the same skin tone but in sunlight and shade, respectively. Merging is context-dependent. For example, an element corresponding to a brownish element could be the shaded part of a Caucasian face, or the brightly lit part of a face with darker skin colour. It will generally be possible to deduce from the other skin tone elements in the skin tone region whether the categories of the brownish elements should be merged with those of elements corresponding to slightly lighter pixels, or with elements corresponding to slightly darker pixels. They should not be merged with both. Similarly, the merging of categories should not go so far as to blend a light face with a white wall, or a dark face with a red/brown wall. It is also desirable to avoid blending faces with the hair surrounding them. Categories that are very different are not merged together.

The map is then searched for contiguous skin tone regions of skin tone elements having similar categories. In the exemplary map 21, the skin tone region 27 containing seventy-one elements would be identified, along with an isolated element 28 corresponding to the small skin tone patch 8 in the image 1.

The process has now identified skin tone regions in the map 21 (corresponding to skin tone regions of the image). In order to ensure that elements such as the background element 28 are not erroneously classed as potential faces, the map is cleaned up by removal of isolated elements that do not look like their neighbourhood. For every skin tone element, a check is made of its eight immediate neighbours. If too few of them (e.g. one or two) are also skin tone elements, it is assumed that this is an isolated element and can be ignored when searching for skin. As mentioned above, an off-white wall could have occasional pixels that are sufficiently pink to look like skin. The removal of isolated elements ensures that such anomalies are removed from the process near the beginning.

The overall shapes of the identified skin tone regions are now checked, and those whose shape is unreasonable for the purposes of face detection are rejected. For example, a very linear region will never correspond to a face. For those shapes which are not rejected, the process executes a validation procedure.

Validation consists of deciding whether a map region is a face or not. There are four face orientations possible—two in portrait mode and two in landscape mode. So the validation has to be repeated up to four times, and it is enough for the region to be accepted in one of these orientations to be considered a face. In practice, the upside-down portrait orientation is unlikely, so it may be skipped. The description below refers to normal portrait orientation. It will be appreciated that the procedure will be identical for other orientations (with suitable changes in direction). Alternatively, the map may be rotated and then the same validation performed on the rotated map.

In some images a face may appear by itself, with the rest of the body covered by non-skin tone clothing and against a non-skin tone background. In such a case the skin tone region would be expected to be generally elliptical, with a height:width ratio approximately equal to 1.4. This may be considered to be the “ideal” case. However, not all images will be like this. If the neck, and possibly a V of the chest, is exposed, the height will be greater. If shoulders, or even further down, is exposed, the shape will be different and both height and width will be higher. If one or two ears are exposed the width will be higher. If hair covers the forehead the height will be lower. It will be appreciated that other variants are also possible. The most effective way to proceed with validation is to consider the most common cases.

The validation process begins by calculating the weighted centre (horizontal and vertical) of the skin tone elements in each skin tone region of the map. The weighted centre has co-ordinates determined by the algebraic average of the co-ordinates of all the skin tone elements in the skin tone region. In addition, a bounding box of each skin tone region is determined. The bounding box is the smallest possible rectangular shape that completely encompasses the skin tone region. A check is made as to the proportion of the bounding box filled by the skin tone region, and those regions where the proportion is below a predetermined value are rejected. A typical threshold value is 60%. This check helps to eliminate shapes unlikely to have been generated by a face.

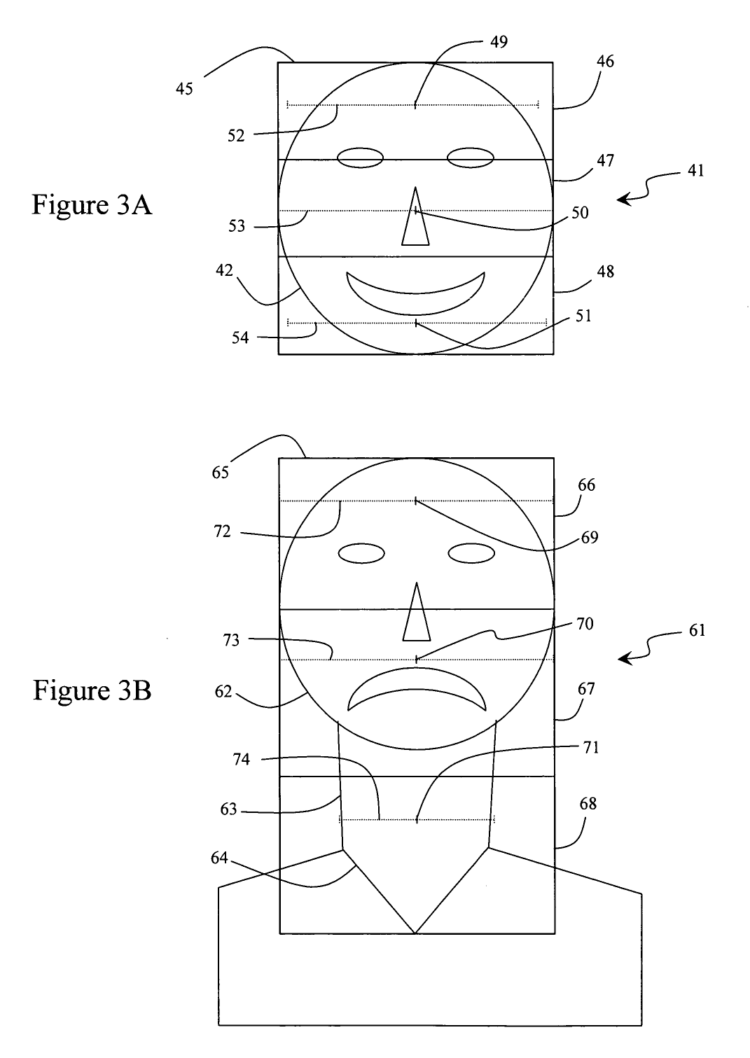

FIG. 3A shows the skin tone region 41 of an “ideal” face 42. FIG. 3B shows the skin tone region 61 of a face 62, neck 63 and “V” 64 of a chest. In each case a bounding box 45,65 has been placed around the skin tone region. The bounding box 45,65 is divided vertically into three segments 46,47,48;66,67,68 extending across the width of the box, each being one third of the height of the box 45,65. In each segment, the weighted horizontal centre 49,50,51,69,70,71 of the skin tone elements contained within that segment is calculated. In addition, the maximum width of the skin tone region contained within each segment is calculated. The maximum widths of the three segments in each of FIG. 3A and 3B are represented as horizontal lines 52,53,54;72,73,74.

The relationships between the horizontal position of the horizontal centres 49,50,51,69,70,71, maximum widths 52,53,54,72,73,74 of the skin tone region in the segments, and overall height of the bounding box 45,65 are used to determine what type of face the skin tone region could correspond to. In the example shown in FIG. 3A, where just a face is present, the horizontal centres 49,50,51 are substantially vertically aligned and the maximum widths 52,53,54 are similar, with the width 53 from the middle segment being slightly greater than the widths 52,54 from the upper and lower segments. The ratio of the three (similar) widths 52,53,54 to the overall height of the bounding box 45 is approximately 1:1.5. Thus a skin tone region which satisfies this set of criteria may be presumed to correspond to an “ideal” face region of the type shown in FIG. 3A.

In the example shown in FIG. 3B, where the neck 63 and some of the chest 64 is exposed, the horizontal centres 69,70,71 are again substantially aligned. However, the maximum width 74 from the bottom segment is smaller than the maximum width from the middle and top segments 73,72. The overall width:height ratio for the example of FIG. 3B is approximately 1:2. Thus a skin tone region having this set of criteria may be presumed to correspond to a face with the neck and possibly some chest exposed.

It will be appreciated that similar rules may be devised for other types of skin tone region. If one shoulder is exposed, the bottom width will be larger than the top two widths, and the bottom horizontal centre will be laterally offset from the top two. If both shoulders are exposed the bottom width will be significantly larger than the top two, and the horizontal centres will be substantially aligned. If the “ideal” face of FIG. 3A is modified by uncovering the ears, the width:height ratio will move closer to 1:1 and the central width will be larger than the outer two. Similarly, hair covering the forehead will reduce the height of the skin tone region. Other rules will be apparent to the person skilled in the art. These rules should also cater for the situation of a face at least partially turned away from the camera. If the skin tone region satisfies none of the set of rules, it is rejected as a face candidate.

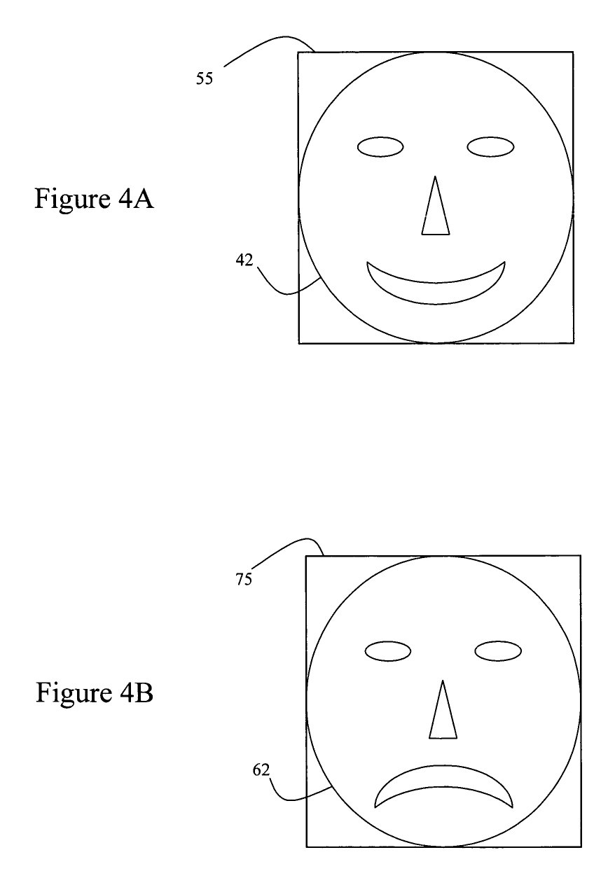

Once the “type” of skin tone region has been established, a “face region” is isolated from the overall skin tone region. FIGS. 4A and 4B show the face regions 42,62 from the skin tone regions 41,61 shown in FIGS. 3A and 3B, respectively. The face region 41 and skin tone region 42 of the “ideal” face in FIGS. 3A and 4A are identical. Thus, when it is recognised that an “ideal” face” is present, the location and size of the face region are defined as the location and size of the skin tone region. A bounding box 55 is calculated around the face region, which in this case will be identical to the bounding box 45 around the skin tone region 41 shown in FIG. 3A.

The face region 62 shown in FIG. 4B is only the top portion of the skin tone region 61 of FIG. 3B. The location and size of the face region can be calculated by knowing what type of face region is being considered and from the top horizontal centres 69,70 and widths 72,73. Once the location and size of the face region 62 is established, a new bounding box 75 is placed around the face region 62. Further procedures ignore the remainder of the skin tone region and concentrate on the face region 62 within its bounding box 75.

The next step is to determine whether the face region has eyes and a mouth in the places which would be expected in a face, and also whether it generically “looks like a face”. This is achieved by matching the face region with a number of templates of typical faces. Before matching, the template is scaled to the size of the face region 42,62 previously determined.

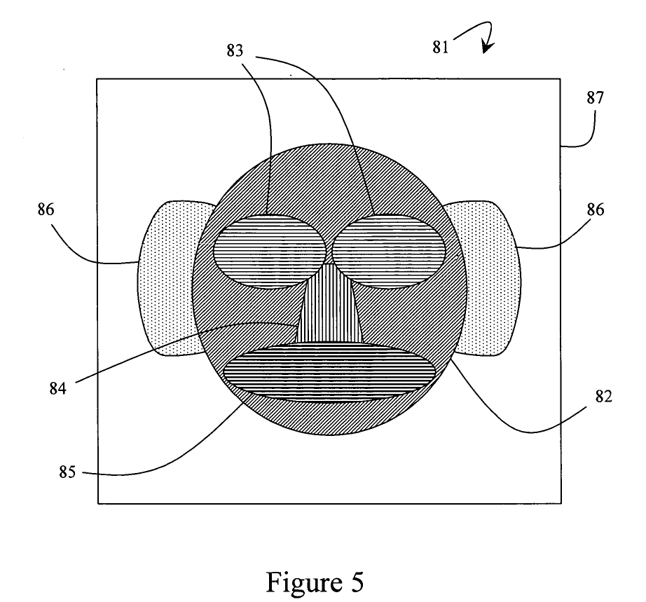

One such template is shown in FIG. 5. It shows, in very rough terms, a face 81 split up into a skin portion 82, two eye portions 83, a nose portion 84, a mouth portion 85, two ear portions 86 and a background portion 87. It will be recalled that elements were initially placed by the table into one of 256 categories. Approximately 128 of these categories correspond to skin tone categories. The remaining categories are used for elements corresponding to pixels having colours characteristic of eyes (e.g. blue, green, brown, pinkish white), and mouths (various shades of red). For a face to match any given template, it would be expected that:
in the skin portion 82, most of the elements would be skin tone elements;
in the eye portions 83, most of the elements would fall into predetermined “eye” categories;
in the nose portion 84, a predetermined proportion of the elements would be skin tone elements (since parts of the nose usually appear a different colour due to its angle);
in the mouth portion 85, most of the elements would fall into predetermined “mouth” categories;
in the ear portions 86, some of the elements might be skin tone elements (depending on whether or not the ears are covered): and
in the background portion 87, none (or very few) of the elements would be skin tone elements.

The elements in each portion of the template are scored depending on how well they fit the set of rules for that template. A positive score is allocated to every pixel that meets expectation (e.g. a skin tone element in the skin portion 82, or an “eye” category element in the eye portion 83) and a negative score to each element that does not meet expectation (e.g. a non-skin tone element in the skin portion 82, or a skin tone pixel in the background portion 87). The score for all of the elements is added up. If the total score is above a certain threshold then the face region is accepted to proceed to the final round of validation. If it is not, then it is decided that this face region does not match the template, and attempts are made to match to further templates. If no templates are found to be a match, the face region is rejected. A range of templates should be used, including templates for faces with and without ears, beards, and hair, and facing directly towards the camera or not. Templates may also be provided for faces in profile: it will be appreciated that there would only be one eye portion in such templates, and the location and size of the eye and mouth portions would be very different.

The scoring takes account of the strength of expectation. In the skin portion 82, for example in the centre of a cheek, there is a high expectation of skin tone elements. Thus elements in this region that are not skin tone elements have a large negative score. At the sides of the nose region, where it might be expected that some elements are skin tone elements and some not, the positive or negative scores assigned to elements are much smaller. Thus it only takes a few wrong elements in “important” places to reject the template match, but many wrong elements will be required in “less important” places.

Further testing is applied using additional criteria such as symmetry of the eyes (whether the number of eye elements is roughly the same in each eye) and ratio of eye elements to mouth elements.

A final check is now made of a sample of pixels in the original image in each accepted face region, in the areas indicated by the template as eye and mouth portions. These pixels do not necessarily correspond to the originally selected pixels from which the map elements were determined. If the colours and placing within the face region of these meet further selection criteria such as symmetry of the eyes and ratio of eye pixels to mouth pixels then it is determined that the face region does correspond to a face in the image, and its location and size is output, for example to a camera operating system to enable the camera to focus on that face in the field of view.

It will be appreciated that variations from the above described embodiments may still fall within the scope of the invention. In particular, the process has been described as a series if steps, each following on from the previous step. However, many of the steps may be carried out independently. It is not necessary to sample the original image before forming a map: it would be possible to produce a map having the same number of elements as the original image. Where the image is only small to start with, this may well be a realistic option. It could also be envisaged, for example, that skin tone regions could be matched to templates without the previous validation steps having taken place, although this will require the use of many more templates. It will be appreciated that each of the above described steps improves the efficiency of the process, but they need not all be used together.

1. A method of detecting a face in a digital image, the method comprising:
forming a sampled image from a plurality of pixels selected from the digital image; and
searching the sampled image for regions of pixels exhibiting characteristics of a face.

2. The method of claim 1, wherein the step of forming a sampled image includes selecting pixels from one out of every m rows and one out of every n columns of the digital image, where m and n are integers greater than one.

3. The method of claim 2, wherein m and n are the same.

4. A method of detecting a face in a digital image, comprising generating a map from the image, the map having a plurality of elements each corresponding to a pixel of the image, and searching the map for regions of elements corresponding to regions of pixels in the image exhibiting characteristics of a face.

5. The method of claim 4, further comprising forming a sampled image from a plurality of pixels selected from the digital image, wherein the map is generated from the sampled image, each pixel of the sampled image having a corresponding map element.

6. The method of claim 4, wherein the map contains 256×256 elements or fewer.

7. The method of claim 4, wherein each map element has a value, each value determined from the colour space data of the corresponding pixel from a look-up table.

8. The method of claim 7, wherein each map element value is expressible as a single byte of data.

9. The method of claim 7, wherein the map element values are subdivided into categories, at least one of the categories corresponding to pixels exhibiting skin tone, so that map elements in the category or categories corresponding to skin tone pixels may be classed as skin tone elements.

10. The method of claim 9, wherein, if the number of skin tone elements in the map is smaller than a predetermined value, it is determined that no face is present in the digital image.

11. The method of claim 9, wherein the step of searching the map for regions of elements corresponding to regions of pixels in the image exhibiting characteristics of a face includes searching the map for regions of skin tone elements, which may be classed as skin tone regions.

12. The method of claim 11, further comprising merging the categories of some or all of the elements in a skin tone region on the basis of the categories of all the elements in that skin tone region.

13. The method of claim 11, wherein, if a skin tone region is below a predetermined size, it is determined that this region does not correspond to a face in the digital image.

14. The method of claim 11, wherein, if the shape of a skin tone region is far from elliptical, it is determined that this region does not correspond to a face in the digital image.

15. The method of claim 11, further comprising performing a validation on each skin tone region to determine whether or not it corresponds to a face in the digital image, said validation being repeated three times following rotation of the map to account for faces extending from top to bottom, left to right and right to left of the image.

16. The method of claim 15, wherein the validation step includes identifying the height: width ratio of each skin tone region and determining that a skin tone region whose height: width ratio falls outside predetermined parameters does not correspond to a face in the image.

17. The method of claim 15, wherein the validation step includes determining a bounding box for a skin tone region by identifying the smallest rectangular shape encompassing the skin tone region.

18. The method of claim 17, further comprising:
calculating what proportion of elements within the bounding box are skin tone elements; and
if the proportion falls outside predetermined parameters, determining that the skin tone region does not correspond to a face in the image.

19. The method of claim 17, wherein the validation step includes:
dividing the bounding box vertically into a plurality of segments extending across the width of the box;
calculating, for each segment, a weighted horizontal centre of the skin tone elements contained in that segment by calculating the mean of the horizontal co-ordinates of the elements within the segment;
calculating, for each segment, a maximum width of the portion of the skin tone region contained in that segment; and
using predetermined rules to examine properties of the segments relative to each other and/or the bounding box.

20. The method of claim 19, wherein each rule includes a test of one or more of:
the relative horizontal position of the weighted horizontal centres;
the relative size of the projected widths; and
the height of the bounding box.

21. The method of claim 19, wherein if the skin tone region satisfies none of the predetermined rules, determining that the associated skin tone region does not correspond to a face in the image.

22. The method of claim 19, wherein, if the skin tone region does satisfy one of the predetermined rules, using that rule to determine the location and size of a face region within the associated skin tone region which could correspond to a face in the image.

23. The method of claim 22, further comprising matching the face region to a plurality of face-shaped templates to determine if it does correspond to a face in the image.

24. The method of claim 23, wherein each face-shaped template comprises some regions in which a high proportion of skin tone elements is expected, and other regions where a low proportion of skin tone elements is expected.

25. The method of claim 24, wherein some regions of each template corresponding to a low expectation of skin tone elements may have high expectations of other categories of element.

26. The method of claim 25, wherein categories into which elements can be placed include categories corresponding to pixels having colour space values characteristic of eyes, lips or hair.

27. The method of claim 24, wherein the step of matching the face region to each template comprises applying a score to each element on the basis of how well the category of that element matches the expected category in the region of the template in which it is located.

28. The method of claim 22, further comprising applying further selection criteria to each face region to determine whether or not it corresponds to a face in the image.

29. The method of claim 28, wherein the further selection criteria include comparing the relative sizes of eye regions and mouth regions within each face region.

30. The method of claim 22, further comprising applying further selection criteria to pixels in each face region of the image, to determine whether or not it corresponds to a face.

31. A method of detecting a face in a digital image, the method comprising:
identifying skin tone regions of pixels in the image having colour space values characteristic of skin colour;
determining a bounding box for a skin tone region by identifying the smallest rectangular shape encompassing the skin tone region;
dividing the bounding box vertically into a plurality of segments extending across the width of the box;
calculating, for each segment, a weighted horizontal centre of the skin tone pixels contained in that segment by calculating the mean of the horizontal co-ordinates of the pixels within the segment;
calculating, for each segment, a maximum width of the portion of the skin tone region contained in that segment;
using predetermined rules to examine properties of the segments relative to each other and/or the bounding box; and
passing or rejecting each skin tone region as corresponding to a face on the basis of the predetermined rules.

32. A method of detecting a face in a digital image, the method comprising:
identifying skin tone regions of pixels in the image having colour space values characteristic of skin colour;
comparing each skin tone region with a plurality of face-shaped templates;
passing a skin tone region as corresponding to a face if it matches at least one of the templates.

33. A method of focussing a camera onto a face in the field of view of the camera, the method comprising:
obtaining a digital image of the field of view;
detecting a face in the digital image using the method of claim 1; and
focussing the camera at the location of the detected face.

34. A method of focussing a camera onto a face in the field of view of the camera, the method comprising:
obtaining a digital image of the field of view;
detecting a face in the digital image using the method of claim 4; and
focussing the camera at the location of the detected face.

35. A method of focussing a camera onto a face in the field of view of the camera, the method comprising:
obtaining a digital image of the field of view;
detecting a face in the digital image using the method of claim 31; and
focussing the camera at the location of the detected face.

36. A method of focussing a camera onto a face in the field of view of the camera, the method comprising:
obtaining a digital image of the field of view;
detecting a face in the digital image using the method of claim 32; and
focussing the camera at the location of the detected face.

37. A method of selecting the exposure for a photograph, comprising:
obtaining a digital image of the area to be photographed;
detecting a face in the digital image using the method of claim 1; and
selecting the exposure of the photograph to optimise the exposure of the detected face.

38. A method of selecting the exposure for a photograph, comprising:
obtaining a digital image of the area to be photographed;
detecting a face in the digital image using the method of claim 4; and
selecting the exposure of the photograph to optimise the exposure of the detected face.

39. A method of selecting the exposure for a photograph, comprising:
obtaining a digital image of the area to be photographed;
detecting a face in the digital image using the method of claim 31; and
selecting the exposure of the photograph to optimise the exposure of the detected face.

40. A method of selecting the exposure for a photograph, comprising:
obtaining a digital image of the area to be photographed;
detecting a face in the digital image using the method of claim 32; and
selecting the exposure of the photograph to optimise the exposure of the detected face.

41. A computer readable medium having stored thereon software arranged when actuated to carry out the method of claim 1.

42. A computer readable medium having stored thereon software arranged when actuated to carry out the method of claim 4.

43. A computer readable medium having stored thereon software arranged when actuated to carry out the method of claim 31.

44. A computer readable medium having stored thereon software arranged when actuated to carry out the method of claim 32.

45. A camera arranged to obtain a digital image and detect a face in the digital image using the method of claim 1.

46. A camera arranged to obtain a digital image and detect a face in the digital image using the method of claim 4.

47. A camera arranged to obtain a digital image and detect a face in the digital image using the method of claim 31.

48. A camera arranged to obtain a digital image and detect a face in the digital image using the method of claim 32.

49. A camera arranged to obtain a digital image, detect a face in the digital image using the method of claim 1, and focus on the detected face.

50. A camera arranged to obtain a digital image, detect a face in the digital image using the method of claim 4, and focus on the detected face.

51. A camera arranged to obtain a digital image, detect a face in the digital image using the method of claim 31, and focus on the detected face.

52. A camera arranged to obtain a digital image, detect a face in the digital image using the method of claim 32, and focus on the detected face.

53. A camera arranged to obtain a digital image, detect a face in the digital image using the method of claim 1, and select a photograph exposure so as to optimise the exposure of the detected face.

54. A camera arranged to obtain a digital image, detect a face in the digital image using the method of claim 4, and select a photograph exposure so as to optimise the exposure of the detected face.

55. A camera arranged to obtain a digital image, detect a face in the digital image using the method of claim 31, and select a photograph exposure so as to optimise the exposure of the detected face.

56. A camera arranged to obtain a digital image, detect a face in the digital image using the method of claim 32, and select a photograph exposure so as to optimise the exposure of the detected face.
